(19) United States
(12) Patent Application Publication
(10) Pub. No.: US 2025/0124291 A1
(43) Pub. Date: Apr. 17, 2025

(54) DYSKINESIA REHABILITATION TRAINING METHOD AND SYSTEM BASED ON ELECTROENCEPHALOGRAM SIGNAL RECOGNITION

(71) Applicant: ANHUI UNIVERSITY, Hefei (CN)

(72) Inventors: Zhao LV, Hefei (CN); Huabin WANG, Hefei (CN); Ping LI, Hefei (CN); Chao ZHANG, Hefei (CN); Cunhang FAN, Hefei (CN); Daoxin ZHANG, Hefei (CN); Lei ZHANG, Hefei (CN); Xinhui LI, Hefei (CN)

(21) Appl. No.: 19/002,647

(22) Filed: Dec. 26, 2024

Related U.S. Application Data
(63) Continuation of application No. PCT/CN2023/134054, filed on Nov. 24, 2023.

(51) Int. Cl. G06N 3/082

(52) U.S. Cl. CPC G06N 3/082

(57) ABSTRACT

The present invention discloses a dyskinesia rehabilitation training method and system based on electroencephalogram signal recognition; the method includes: the convolutional neural network is used to recognize the electroencephalogram signal, analyze the patient's motor intention, convert the motor intention into a control instruction for the exoskeleton device, drive the patient's limb movement by controlling the movement of the exoskeleton device, and assist the patient to complete the movement disorder rehabilitation training. In this method, the self-attention mechanism and self-distillation training were used to establish an electroencephalogram signal recognition model, analyzing the patient's motor intention to help motor nerve remodeling, which broke the passive and single problem of traditional rehabilitation methods, realized active rehabilitation of patients, and significantly improved the rehabilitation efficacy.

### CROSS-REFERENCE TO RELATED APPLICATIONS

This application is a continuation of International Patent Application No. PCT/CN2023/134054, filed on Nov. 24, 2023. The content of the aforementioned applications, including any intervening amendments thereto, are incorporated herein by reference.

### TECHNICAL FIELD

The present invention relates to the field of electroencephalogram signal processing technology, and in particular, to a dyskinesia rehabilitation training method and system based on electroencephalogram signal recognition.

### BACKGROUND

A motor imagery electroencephalogram signal contains movement-related nerve activity information, and collection and classification recognition using a brain-computer interface technique are a good solution for helping a dyskinesia patient to recover a motor ability efficiently. But there are two major challenges at present: 1. the characteristics of weakness, non-stationarity and nonlinearity of the electroencephalogram signal complicate feature extraction; 2. high real-time requirements including a high recognition speed and precision exist.

For the above problems, in traditional electroencephalogram signal decoding, manual feature extraction is performed on the signal based on machine learning, recognition accuracy depends on effectiveness of feature selection, and data has single features and is subjected to more noise interference; although an application of a deep learning technique can extract effective identification features from the complex electroencephalogram signal, an obtained network model has a complex structure, cannot meet the real-time requirement of rehabilitation training, and needs a certain number of data sets for training, and long-time training may cause fatigue of the patient to result in a poor data effect.

Therefore, how to design the electroencephalogram signal recognition model to enable the electroencephalogram signal recognition model to efficiently filter the electroencephalogram signal to remove the noise interference, extract spatially and temporally deep features in multiple dimensions and multiple scales by using a limited quantity of data, and lighten the network structure to increase the recognition rate as much as possible while improving the classification recognition precision is a key problem which must be faced and solved in an application of multi-class electroencephalogram signal recognition research in limb dyskinesia rehabilitation training at present.

Based on the above problem, the present invention designs an electroencephalogram signal recognition model through deep learning, inputs the patient's electroencephalogram signal, identifies the patient's motor intention through the neural network model, determines the control instruction for the exoskeleton device by using the motor intention, and transmits the control instruction to the exoskeleton device through TCP/IP wireless communication, so as to drive the patient's limb movements through the control exoskeleton device and assist the patient's dyskinesia rehabilitation training. The self-designed model of the present invention has low complexity, can respond at the millisecond level, timely control the exoskeleton to assist the patient's movement, form a closed-loop stimulus, realize the non-delay interactive rehabilitation under the patient's autonomous control, and help the patient's motor nerve remodeling.

### SUMMARY

In view of the problems existing in the prior art, the present invention provides a dyskinesia rehabilitation training method and system based on electroencephalogram signal recognition, which aim at extracting features for better representing motor imagery to improve signal recognition precision, and meanwhile increasing a forming speed, and guaranteeing a recognition rate of a motor imagery electroencephalogram signal, so as to realize high-speed and efficient dyskinesia rehabilitation training. In order to achieve the above purpose, the present invention provides the following technical solution.

In a first aspect, there is provided a dyskinesia rehabilitation training method based on electroencephalogram signal recognition, including:
performing off-line training on a patient, collecting multi-modal electroencephalogram signal when the patient imagines different movement types to obtain the training phase data;
training the training stage data based on the self-attention convolutional neural network architecture to obtain an electroencephalogram signal recognition model;
collecting an electroencephalogram signal of the patient during on-line training as rehabilitation phase data, and inputting the rehabilitation phase data into the electroencephalogram signal recognition model to obtain a classification recognition result; and the motor control command was obtained based on the recognition results;
driving a corresponding limb to move based on the control command to complete dyskinesia rehabilitation training for the patient.

In a second aspect, there is provided a dyskinesia rehabilitation training system based on electroencephalogram signal recognition, comprising:
The electroencephalogram-evoked displays to present images of motor imagery stimuli to guide patient training;
The electroencephalogram acquisition device, which is used to collect electroencephalogram signals for patients to carry out motor imagination processes;
The electroencephalogram signal amplifier for amplifying the electroencephalogram signal to obtain a multi-modal electroencephalogram signal and transmitting it; One end of the electroencephalogram signal amplifier is connected to the electroencephalogram acquisition device to receive the electroencephalogram signal collected by the electroencephalogram acquisition device; The other end is connected to the processor through the USB interface to transmit multi-modal electroencephalogram signals;
The processor for analyzing and processing multi-modal electroencephalogram signal to train and obtain electroencephalogram signal recognition model and generate control instructions;
The exoskeleton device transmits control instructions with the processor through the TCP/IP protocol, and is used to control the patient's exoskeleton to achieve corresponding movement actions after identifying the control instructions.

The dyskinesia rehabilitation training method and system based on electroencephalogram signal recognition according to the present invention have the following beneficial effects.
1. In the present invention, the electroencephalogram signal is filtered and standardized from the frequency domain and the space domain, thus effectively reducing an influence of the irrelevant noise. The improved common space mode algorithm expands a two-classification algorithm to a multi-classification range to maximize the difference of the variance values of the multiple classes of signals, thus greatly reducing complexity and time overhead of the whole algorithm. The problem that feature values of different classifications in a common space mode obtained by a plurality of classification tasks are possibly the same is considered, and on the premise of a maximum importance degree, fewer feature vectors are selected as much as possible by judging whether the feature values are the same, which can guarantee a requirement of a projection space with a maximized energy difference of the multiple classes of electroencephalogram signals, and meanwhile effectively reduce dimensions of the feature vectors, and compared with the prior art in which the feature values are directly used for selection, the electroencephalogram signals for different movement types can be filtered and classified accurately.
2. In the present invention, a multi-head self-attention mechanism with multiple time attention degrees is adopted to establish a global self-attention module group, the input data is expressed in different dimensions while a relationship among all the data in a spatial-temporal feature sequence of the electroencephalogram signal is considered, thus improving a capability of expression of global relevant information. In the present invention, an attention weight matrix is compressed from a global level, more attention is paid to effective features of some key time frames, a number of dot product operations is reduced, and a speed of the feature extraction is increased. Due to a mean feature and fusion of plural self-attention units with different time attention degrees, the foregoing compression process which only focuses on important information is compensated, and compared with a self-attention mechanism of the prior art in which secondary information is directly neglected during weighted average calculation, integrity of the feature extraction of the electroencephalogram signal can be improved.
3. In the present invention, considering that addition of the multi-head self-attention mechanism with the multiple time attention degrees in the extraction of complex characteristics and body features of the electroencephalogram signal complicates the feature extraction process, the electroencephalogram signal recognition model is optimized from the feature distillation and the logic distillation using self-distillation training, and a network with more parameters and a more complex structure is abstracted into a target network with a smaller scale and a smaller time delay, which can reduce the complexity of the network structure to ensure that the complexity and real-time requirements of the electroencephalogram signal are met. In the feature distillation, the student model matched with a self-selection teacher is adopted to allow shallow features to select deep features suitable for learning and approach the deep features for knowledge supervision training of feature similarity; in the logic distillation, a difference between the classification results of two different depth layers is obtained through classification loss, so that a shallow network can be better guided to learn spatial features.
4. In the dyskinesia rehabilitation training method and system based on electroencephalogram signal recognition according to the present invention, the signal is preprocessed in multiple aspects before feature extraction, thus effectively filtering out the noise and better separating different signals; in the feature extraction process, the complexity of the established model is low, features are extracted from temporal and spatial dimensions, the self-attention mechanism with the multiple time attention degrees is integrated to capture correlation of global time positions of the features, and meanwhile, self-distillation learning is added to accelerate fitting of the network to improve a real-time performance of the system. Introduction of optimization limitation of multiple loss functions improves the classification recognition capability, and the efficient and accurate rehabilitation training process is completed.

### BRIEF DESCRIPTION OF DRAWINGS

FIG. 1 is a schematic flow diagram of a dyskinesia rehabilitation training method based on electroencephalogram signal recognition according to the present invention;

FIG. 2 is a schematic diagram of the process of obtaining an electroencephalogram signal recognition model based on a self-attention convolutional neural network architecture in an embodiment of the present invention;

FIG. 3 is a schematic flow diagram of space domain filtering using an improved common space mode algorithm in the present invention;

FIG. 4 is a schematic structural diagram of a self-attention convolutional neural network established in the present invention;

FIG. 5 is an exploded structure block diagram of a global self-attention module group with multiple time attention degrees in the present invention;

FIG. 6 is a schematic block diagram of a dyskinesia rehabilitation training system based on electroencephalogram signal recognition according to the present invention;

In the figure, 1. electroencephalogram-evoked display; 2. electroencephalogram acquisition device; 3. electroencephalogram signal amplifier; 4. Processor; 5. Exoskeleton device.

### DESCRIPTION OF EMBODIMENTS

The technical solutions in the embodiments of the present invention are clearly and completely described below with reference to the accompanying drawings in the embodiments of the present invention, and apparently, the described embodiments are not all but only a part of the embodiments of the present invention. All other embodiments obtained by a person of ordinary skill in the art based on the embodiments of the present invention without creative efforts shall fall within the protection scope of the present invention.

The present invention is aimed at the traditional limb rehabilitation, the patient passively receives mechanical training, lacks the active participation of the brain, and has limited effect on motor nerve repair, and develops a new type of brain-computer interface rehabilitation method and system. The patient wears an electrode cap and decodes the patient's electroencephalogram information through data transmission, recognizes the imaginary movements of the left hand, right hand, and feet, so as to control the exoskeleton device, and realizes the active rehabilitation of the patient under the “mind control”.

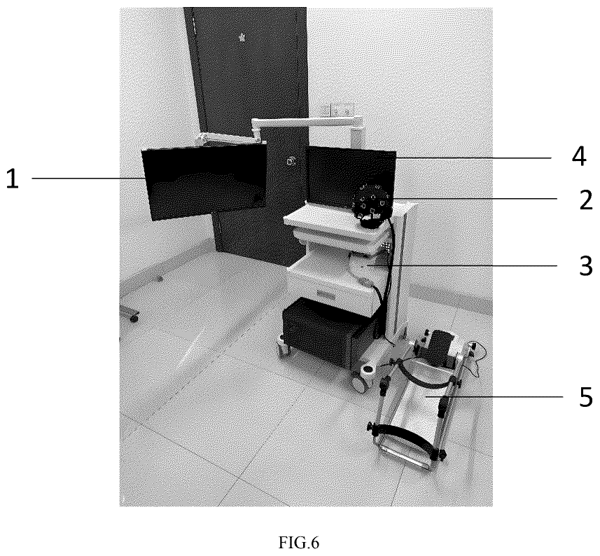

As shown in FIG. 6, an embodiment of the present invention provides a dyskinesia rehabilitation training method based on electroencephalogram signal recognition, including:

The electroencephalogram-evoked displays 1 to present images of motor imagery stimuli to guide patient training.

That is, the stimulus image of different movement actions is presented in front of the patient's eyes through the monitor, in this embodiment, including left-handed, right-handed, and two-foot action, so as to assist the patient in imagining the movement of the corresponding limb.

The electroencephalogram acquisition device 2 is used for collecting the electroencephalogram signal of the patient in the process of motor imagination. In the present embodiment, a 32-lead saline electroencephalogram cap placed according to the position of the 10-20 international system is used as an electroencephalogram acquisition device 2 for collecting electroencephalogram signals when the patient is imagining for movement. Among them, the electroencephalogram cap should be worn in a reasonable position, for example, the “C3”, “CZ”, and “C4” electrodes should be located directly above the top of the head, and the papillae should be wiped with scrub and wiped off, and then the reference electrode should be connected. The original electroencephalogram signal sampling frequency is 250 Hz. According to the standard motion imaging experiment paradigm to collect, each dataset contained 75 single trials for 4 seconds. That is, 1000 data sample points, among them, there are 25 left-handed, right-handed and foot movement imagination samples each.

The electroencephalogram signal amplifier 3 for amplifying the electroencephalogram signal to obtain a multi-modal electroencephalogram signal and transmitting it; wherein one end of the electroencephalogram signal amplifier is connected to the electroencephalogram acquisition device 2 and receives the electroencephalogram signal collected by the electroencephalogram acquisition device; The other end is connected to the processor 4 through the USB interface, and the multimodal electroencephalogram signal is transmitted. In the present embodiment, we use Neuroscan amplifiers.

The processor 4 for analyzing and processing multi-modal electroencephalogram signal to train and obtain electroencephalogram signal recognition model and generate control instructions.

The exoskeleton device 5 transmits control instructions with the processor through the TCP/IP protocol, and is used to control the patient's exoskeleton to achieve corresponding movement actions after identifying the control instructions.

In an embodiment, the exoskeleton device 5 may be a brain-controlled wheelchair robot, and for a patient with a stroke lower limb disorder with basic mobility ability, the left/right leg of the control command control device is carried out a leg-lifting movement, and an imaginary task comprises lifting the leg and putting it down. In another embodiment, the exoskeleton device 5 may also be a brain-controlled upper and lower limb exoskeleton robot, which carries out autonomous rehabilitation for the ICU patient who is lying in bed, and the control command controls the left/right hands to lift and put down, and the left/right feet bend the knees and straighten the movements.

The present invention utilizes brain-computer interface technology to regulate brain signals through active training to improve its functionality and connectivity. In addition, the end-to-end method of deep learning is used to establish the prediction results of the recognition model, and the self-attention mechanism and self-distillation learning are used to improve the real-time performance of the recognition model, and the two-way closed-loop stimulation of nerves and limbs is efficiently formed, that is, “center-peripheral-center”, which helps motor nerve remodeling, breaks the passive and single problem of traditional rehabilitation methods, realizes active rehabilitation of patients, has a high degree of personalization, and significantly improves the rehabilitation efficacy.

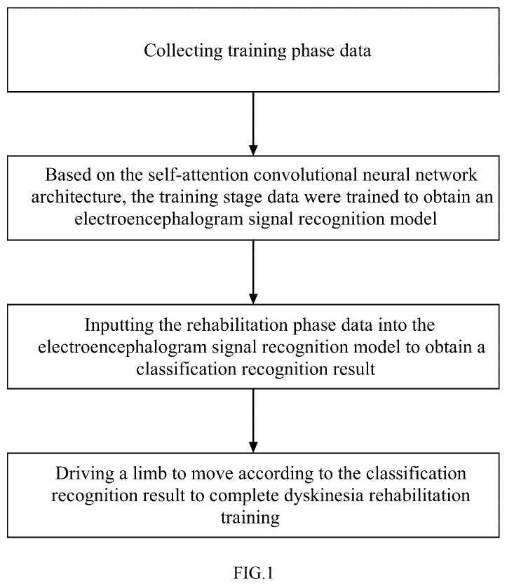

In order to facilitate the understanding of the present embodiment, the following is a detailed introduction to the dyskinesia rehabilitation training method based on electroencephalogram signal recognition disclosed in the embodiment of the present invention. This is shown in FIG. 1, including:

Performing off-line training on a patient, collecting multi-modal electroencephalogram signal when the patient imagines different movement types to obtain the training phase data.

Rehabilitation training of the patient includes two parts: a training phase and a rehabilitation phase.

In the training phase, electroencephalogram data of the patient is required to be collected to establish a motor imagery electroencephalogram signal data set with a label for subsequent model training.

Specifically, the patient is trained off-line, the patient puts on the electrode cap and sits in front of the screen, and the countdown appears in the center of the screen for 10 seconds before the formal acquisition begins. The patient visualizes the movement according to the guided pictures of the gestures that appear on the screen, including the left hand, the right hand, and both feet, and the amount of data collected in each category is the same, and after each gesture action picture lasts for 4 s, there will be a rest time of 6 s, and then the next segment appears, and the collection process lasts about 20 minutes. After the acquisition, the electroencephalogram signal data collected to each stage will be labeled and stored.

Training the training stage data based on the self-attention convolutional neural network architecture to obtain an electroencephalogram signal recognition model.

Collecting an electroencephalogram signal of the patient during on-line training as rehabilitation phase data, and inputting the rehabilitation phase data into the electroencephalogram signal recognition model to obtain a classification recognition result; and the motor control command was obtained based on the recognition results.

During the rehabilitation phase, patients undergo rehabilitation tests.

For example, when the patient's brain imagines his right hand, the electrodes on the scalp will record. The collecting module transmits the rehabilitation phase data to a classification recognition module, a trained electroencephalogram recognition model is called to predict a result, and an imagination result is displayed on a screen.

Considering that the electroencephalogram signal may generate a difference over time, the recognition model established during last off-line training of the patient is required to be loaded.

Driving a corresponding limb to move based on the control command to complete dyskinesia rehabilitation training for the patient.

The present invention is based on the electroencephalogram data collected from a certain number of patients in the electroencephalogram signal training stage, and a recognition model is trained based on the self-attention convolutional neural network architecture and the self-distillation learning idea of the neural network. In the rehabilitation stage, according to the electroencephalogram data imagined by themselves, the prediction results are input into the recognition model to generate control instructions to control the movement of the exoskeleton. Realize the delay-free interaction between patients with movement disorders and external devices, and complete the efficient and accurate rehabilitation training process.

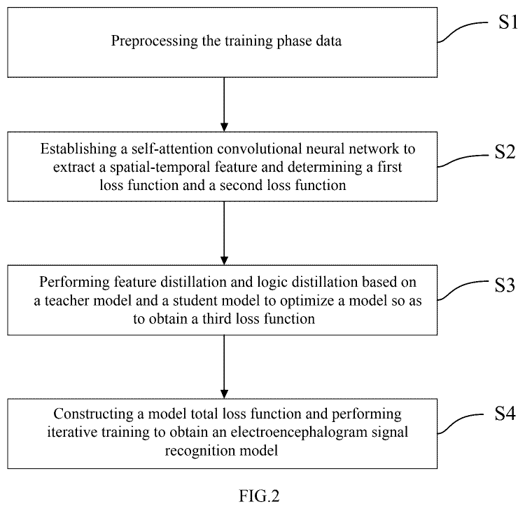

Refer to FIG. 2, as a preferred way of implementation, wherein training the training stage data based on the self-attention convolutional neural network architecture to obtain an electroencephalogram signal recognition model comprises:
S1, preprocessing the training stage data, which sequentially comprises: establishing a frequency domain filter based on band-pass filtering, performing standardization, and improving a common space mode algorithm to establish a space domain filter;
S2, establishing a self-attention convolutional neural network to extract a spatial-temporal feature of the electroencephalogram signal, determining a first loss function based on a predictive classification and a real classification of the self-attention convolutional neural network, and determining a second loss function based on a distance between the spatial-temporal feature and a corresponding spatial-temporal feature center;
S3, performing model optimization on the self-attention convolutional neural network in a self-distillation mode to obtain a third loss function;
S4, constructing a model total loss function based on a linear combination of the first loss function, the second loss function and the third loss function, and performing iterative training on the self-attention convolutional neural network to obtain an electroencephalogram signal recognition model.

The preprocessing operation of the step S1 includes:

S11: performing band-pass filtering, and performing 4-40 Hz band-pass filtering on the data by using a Chebyshev II filter to filter out frequency components irrelevant to the movement. A transfer function is:

$${\vert H ( ω ) \vert}^{2} = \frac{1}{1 + \frac{1}{{ε}^{2} {T}_{n}^{2} ( {ω}_{0} / ω )}} ,$$

wherein ω₀ is an effective band-pass cut-off frequency, ε is a parameter related to a passband ripple, 0<<<1, Tₙ is an N-order Chebyshev polynomial, and a 6-order Chebyshev filter is used to keep a rhythm related to a motor imagery task in the present invention.

S12: normalizing by using Z-score standardization to balance and normalize the non-standardized electroencephalogram signal, so as to eliminate fluctuation interference in the collecting process:

$${X}_{0} = \frac{{x}_{i} - μ}{\sqrt{{σ}^{2}}} ,$$

wherein x₁ and x₀ represent the data and standardized output after the band-pass filtering respectively, and μ and σ² represent a mean and a variance of training data respectively.

The preprocessing of the multi-modal electroencephalogram signal can reduce influences of noise and other non-research factors on the feature extraction and decoding processes of the electroencephalogram signal, thereby extracting useful signal components. The band-pass filtering can filter out irrelevant high-frequency noise and low-frequency noise, and the standardization can reduce volatility and non-stationarity of the data and is beneficial to model training.

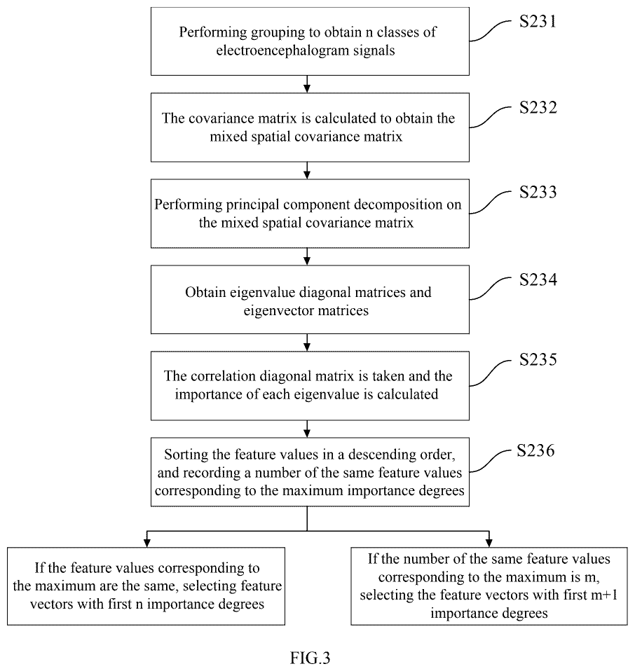

S13: designing the space domain filter by adopting the improved common space mode algorithm, wherein three classifications of the electroencephalogram signals are taken as an example in the present embodiment, referring to FIG. 3, and specific steps are as follows:

S131: grouping the multi-modal electroencephalogram signals according to movement types to form n classes of electroencephalogram signals, n being a total number of the movement types of the electroencephalogram signals.

S132: calculating a normalized covariance matrix R̅₁̅ of each class of electroencephalogram signals, i representing different movement types; obtaining a mixed spatial covariance matrix R of the multi-modal electroencephalogram signals.

Specifically, a covariance matrix Ri of each class of electroencephalogram signals is calculated:

$${R}_{i} = \frac{{X}_{i} {X}_{i}^{T}}{trace ( {X}_{i} {X}_{i}^{T} )} ,$$

wherein Xᵢ is the electroencephalogram signals for different movement types, T represents matrix transposition, and trace ( ) represents a sum of elements on diagonal lines of the matrix;
a mean of the covariance matrix Ri of each class of electroencephalogram signals is calculated to obtain the normalized covariance matrix R̅₁̅;
the mixed spatial covariance matrix R is: R=R̅₁̅+R̅₂̅+̅ . . . +R̅₁̅+ . . . +R̅ₙ̅.

S133: performing principal component decomposition on the mixed spatial covariance matrix R of the electroencephalogram signals: R=UVU^{T},
wherein V is a feature value diagonal matrix, and U is a feature vector matrix corresponding to feature values in V.

S134: solving a common feature vector matrix Si based on the normalized covariance matrix R̅₁̅ and the principal component decomposition of each class of electroencephalogram signals, and performing principal component decomposition on Si in the mode of the step S233 to obtain a feature value diagonal matrix Vi and a feature vector matrix Ui corresponding to the feature value diagonal matrix Vi of each class of electroencephalogram signals.

Specifically, the solving of the common feature vector matrix Si includes:
calculating a whitening matrix P, P=\sqrt{V⁻¹}U^{T}; the common feature vector matrix Si being Sᵢ=PR̅₁̅P^{T}; and
performing principal component decomposition on the common feature vector matrix Si in the mode of the step S133 to obtain the feature value diagonal matrix Vi and the feature vector matrix Ui corresponding thereto of each class of electroencephalogram signals: Sᵢ=UᵢVᵢUᵢ^{T}.

U₁=U₂= . . . =Uᵢ, V₁+V₂+ . . . +Vᵢ=I, and I is an identity matrix.

Using the steps S231-S234, U₁=U₂=U₃, and V₁+V₂+V₃=I.

Since a classical common space mode algorithm is a space domain filtering method for a two-classification task, and multi-class motor imagery is included in the present invention, the algorithm is required to be expanded.

S135: performing approximate joint diagonalization on all the common feature vector matrixes Si to obtain relevant diagonal matrixes corresponding to the classes of electroencephalogram signals, and calculating an importance degree of each feature value λⱼ in each relevant diagonal matrix; the importance degree being the greater of the feature value λⱼ and an inverse proportional function of the feature value λⱼ.

It should be understood that the approximate joint diagonalization of the matrix is the art and is not repeated herein.

Specifically, the importance degree is the greater of the feature value λⱼ and

$$τ = \frac{1 - {λ}_{j}}{1 + α {λ}_{j}} ;$$

τ is the inverse proportional function of the feature value λⱼ, and a is determined according to the number of the classification tasks.

S136: sorting the feature values λⱼ in each relevant diagonal matrix in a descending order according to the importance degree, and recording a number of the same feature values λⱼ corresponding to the maximum importance degrees in the relevant diagonal matrixes.

In the existing common space mode algorithm, a maximum feature value is selected to construct the filter after the feature values are sorted, but considering that the feature values of different classifications in common space mode space domain filtering obtained by a plurality of classification tasks may be the same, in the present invention, the proper feature value is selected by using the importance degree of the feature value.

S137: if the feature values λⱼ corresponding to the maximum importance degrees in the relevant diagonal matrixes are the same, performing space domain filtering by adopting feature vectors corresponding to the feature values λⱼ with first n importance degrees.

In the present embodiment, n=3, and if the feature values with the greatest importance degrees are all the same, first three columns of the relevant feature vector matrix corresponding to the relevant diagonal matrix are selected.

If the number of the same feature values λⱼ corresponding to the maximum importance degrees in the relevant diagonal matrixes is m, and m<n, the space domain filter is established by adopting the feature vectors corresponding to the feature values λⱼ with first m+1 importance degrees.

In the present invention, sorting is performed using the importance degree of the feature value, thus avoiding that different motor imagery classifications may correspond to the same feature vectors, and solving the problem that a common space mode is only suitable for two classifications of searching the maximum and minimum feature values.

A matrix formed by the feature vectors corresponding to the feature values is recorded as the relevant feature vector matrix, and in the present embodiment, n=3, that is; m may be 0 or 1 (when m=2, the feature vectors are the same);
if m=0, that is, the feature values λⱼ corresponding to the maximum importance degrees in the relevant diagonal matrixes are different, space domain filtering is performed using the feature vectors corresponding to the feature values with the maximum importance degrees in the relevant diagonal matrixes; that is, a first column of the relevant feature vector matrix is selected.

If m=1, that is, two of the feature values λⱼ corresponding to the maximum importance degrees in the relevant diagonal matrixes are the same, space domain filtering is performed using the feature vectors corresponding to the feature values with first m+1=2 columns of importance degrees in each class; that is, first two columns of the relevant feature vector matrix are selected.

The space domain filtering step after the feature value selection in the present invention is the same as the common space mode algorithm in the prior art, and is not repeated herein.

A difference of variance values of the multiple classes of signals is maximized using the common space mode algorithm, so as to obtain the feature vector with a higher distinction degree. In consideration of limitation of a classification number and the problem that the feature values of different classifications in the common space mode space domain filtering obtained by the plurality of classification tasks are possibly the same, in the present invention, the common space mode algorithm is improved by adopting the importance degree of the feature value and judging whether the selected feature values are the same, so as to expand the common space mode algorithm of two classifications to a multi-classification range, and compared with one-to-one and one-to-many strategies in the prior art, complexity and time overhead of the whole algorithm can be greatly reduced. Meanwhile, on the premise of the maximum importance degree, fewer feature vectors are selected as much as possible by judging whether the feature values are the same, which can guarantee a requirement of a projection space with a maximized energy difference of the multiple classes of electroencephalogram signals, and meanwhile effectively reduce dimensions of the feature vectors, and compared with the prior art in which the feature values are directly used for selection, the electroencephalogram signals for different movement types can also be filtered and classified more accurately.

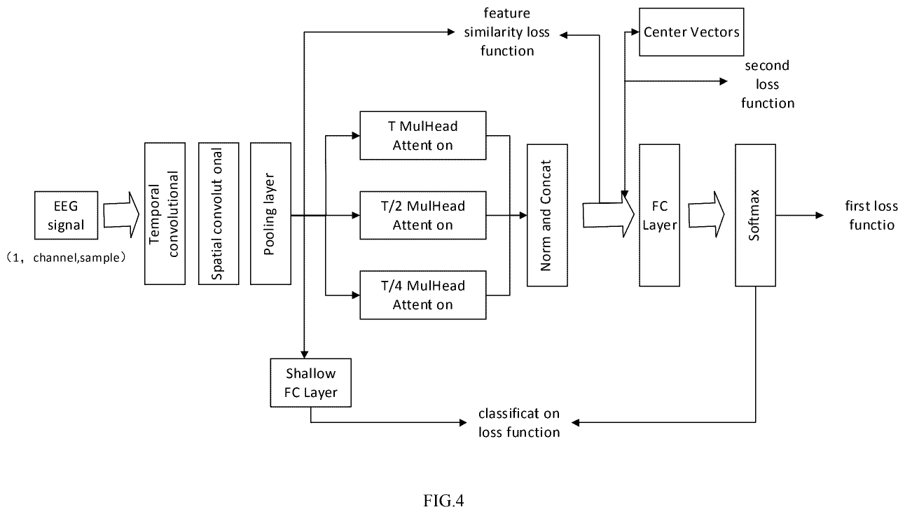

As shown in FIG. 4, the self-attention convolutional neural network in the step S2 has the following structure:
Feature extraction layer: for performing time domain and space domain convolution along a temporal dimension and a lead channel dimension to extract the spatial-temporal feature, and extracting temporal global relevant information of the signal from the spatial-temporal feature through a self-attention module. The feature extraction layer specifically includes four layers:
a first layer for performing a convolution operation using k convolution kernels with a size of (1, 25) and a step length of (1, 1) to extract a time domain feature of the electroencephalogram signal;
a second layer for using a kernel with a size of (N, 1) and a step length of (1, 1) to extract a space domain feature;
a third layer which is a temporal-dimension pooling layer, and has a kernel with a size of (1, 75) and a step length of (1, 15); the third layer being configured to smooth the temporal feature, so that overfitting is avoided, and calculation complexity is reduced; and
a fourth layer for obtaining correlation of global time positions using the self-attention module. The defect that the convolution operation focuses on local receptive fields can be effectively made up, and the obtained features have higher distinguishing value.

Central loss layer: for setting an initial central point of each electroencephalogram signal class as a zero vector or a random vector, outputting the spatial-temporal feature of the fourth layer of the feature extraction layer of the convolutional neural network as a sample feature vector, and calculating an Euclidean distance between each sample feature vector and a central point of the corresponding class as the second loss function.

The central loss layer is configured to shorten a distance of the same class of electroencephalogram signals and increase a distance between different classes of electroencephalogram signals, so as to improve a performance of the electroencephalogram signal recognition model.

Classification layer: for predictively classifying the spatial-temporal feature extracted by the feature extraction layer using a fully-connected layer classifier, and calculating a cross entropy loss function between a predictive classification result and a real electroencephalogram classification label as the first loss function.

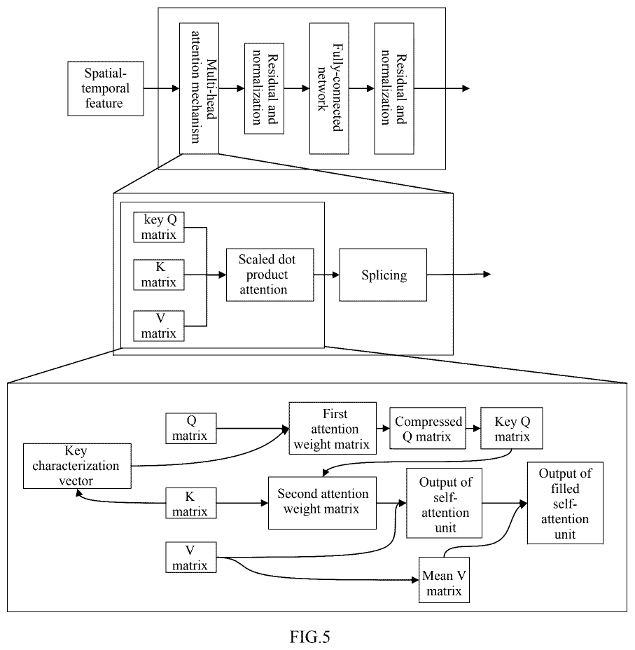

The self-attention module is a global self-attention module group, a multi-head scaled dot product attention mechanism is adopted for a self-attention unit, the self-attention unit with each time attention degree includes a multi-head self-attention mechanism and a fully-connected network, and a residual connection and normalization module is connected behind the multi-head self-attention mechanism and the fully-connected network; the plurality of self-attention units with different time attention degrees are connected in parallel through a splicing normalization layer. A specific structure of the global self-attention module group in the present invention is shown in FIG. 5.

Output of the global self-attention module group in the present invention is

$$QMulH = Norm ( Concat ( {MulH}^{T} , {MulH}^{\frac{T}{2}} , {MulH}^{\frac{T}{4}} ) )$$

wherein Norm is a layer normalization operation, and MulH^{T} represents the output of the self-attention unit with the time attention degree T.

The multi-head self-attention mechanism expresses the input data in different dimensions while considering a relationship among all the data in a spatial-temporal feature sequence, and different attention information is captured, thus improving a capability of expression of global relevant information. Residual connection can provide cross-layer connection for feature information, thereby lowering training difficulty of a deep neural network; the output of each self-attention module is subjected to same distribution through layer normalization, so that the global self-attention module group can adapt to a change of a compression degree of an attention matrix by different time attention degrees, and thus, the model converges more quickly.

In the present invention, the establishing of the global self-attention module group specifically includes:

S71: determining the time attention degrees of the plurality of self-attention units based on a time sequence length of the spatial-temporal features and a number of the self-attention units, and establishing the plurality of self-attention units with different time attention degrees which are connected in parallel to form the global self-attention module group.

The global self-attention module group includes the plurality of self-attention units, and the plural self-attention units have same internal structures and different time attention degrees; that is, the self-attention units focus on different time receptive fields.

Specifically, in the present embodiment, three self-attention units with different time attention degrees are adopted, the time attention degrees are T, T/2 and T/4 respectively, T is the time sequence length of the spatial-temporal feature sequence, and the time receptive fields are the whole/a half/a quarter of the spatial-temporal feature sequence respectively; that is, when the sequence is processed, each element is associated with other elements in the whole/half/quarter of the sequence, and relative importance between the elements is calculated to adaptively capture a long-range dependency relationship between the elements.

S72: performing linear mapping on the spatial-temporal features based on the self-attention units with different time attention degrees to obtain attention matrixes under the corresponding time attention degrees: Q matrix, K matrix and V matrix; the attention matrixes having the same dimensions with matrixes of the spatial-temporal features.

Linear mapping formulas are: Q=XW^{q}, K=XW^{k} and V=XW^{v}. X is the spatial-temporal feature sequence, and W^{q}, W^{k} and W^{v} are learnable weight matrixes required to map X into Q, K and V respectively.

Considering that the electroencephalogram signal shows a periodic change in the time domain, the change between adjacent time frames is relatively slow, and thus, a feature change is not obvious, the time sequence length is required to be compressed, and important time frames are extracted.

S73: calculating an accumulated feature value of each feature vector under the same time frame in the K matrix in the corresponding self-attention unit to extract a key characterization vector from the K matrix.

S74: calculating a first attention weight matrix based on the key characterization vector and the Q matrix, and compressing the Q matrix according to weights in the first attention weight matrix to obtain a compressed Q matrix.

S75: completing a dimension of the compressed Q matrix to be the same as a dimension of the K matrix by using a zero vector to obtain a key Q matrix.

Since subsequent attention weights require a dot product operation of the K matrix and the Q matrix, and the dimensions of the K matrix and the Q matrix are required to be guaranteed to be the same, the zero vector is filled in the time frame corresponding to a Q value removed during compression.

S76: calculating a second attention weight matrix based on the K matrix and the key Q matrix, and performing weighted summation on the V matrix to obtain

$${A}_{2} = \frac{\overline{Q} {K}^{T}}{\sqrt{d}}$$

the output of the corresponding self-attention unit;
wherein Q is the compressed Q matrix, d is the dimension of the K matrix, and T represents transposition of the matrix. Then, the output of the self-attention unit is:

$$MulH = Concat ( {head}_{1} , {head}_{2} , … , {head}_{h} ) W$$

$${head}_{h} == softmax ( {A}_{2 , h} \cdot {V}_{h} ) = softmax ( \frac{\overline{{Q}_{h}} {K}_{h}^{T}}{\sqrt{d}} ) {V}_{h}$$

wherein Concat represents the splicing operation, A_{2,h} represents a second weight matrix of an h-th self-attention head, headₕ represents the h-th self-attention head, and W is a learnable parameter matrix and is used for fusing multi-head self-attention information.

S77: performing mean filling on the output of the self-attention unit by using the V matrix of the spatial-temporal features.

S771: calculating a mean of the V matrix of the spatial-temporal features in a range of the corresponding time attention degrees.

When the time attention degrees are T, a mean calculation formula is:

$$\overline{V} = \frac{1}{T} ( \sum {V}_{i , 1} , \sum {V}_{i , 2} , ⋯ , \sum {V}_{i , T} )$$

T is the time attention degree, and V_{i,T} is an ith V value of the spatial-temporal feature under the Tth time frame of the V matrix.

When the time attention degrees are T/2 and T/4, T in the above formula is changed into T/2 and T/4.

S772: replacing data 0 in the output of the self-attention unit with the mean.

The original Q matrix is compressed, the weight of a non-critical time frame in the attention weight matrix is directly ignored, weakness and complexity of the electroencephalogram signal are considered, partial signal features may be lost due to direct ignoring to cause a result deviation, and therefore, the mean V matrix is used to replace a 0 vector before output splicing; that is, a relatively unimportant time frame signal is replaced by a global average feature, thus improving integrity of the feature extraction of the electroencephalogram signal.

S78: executing S72-S77 for the self-attention units with different time attention degrees of the global self-attention module group.

S79: splicing and normalizing the output of the self-attention units with different time attention degrees to obtain output of the global self-attention module group, i.e., the temporal global relevant information of the electroencephalogram signal.

The attention weight matrix is compressed from a global level through the key characterization vector and the mean of the spatial-temporal features in the range of the time attention degrees, so that loss of the spatial-temporal features is reduced as much as possible while self-attention calculation times and complexity in the prior art are reduced, and more attention is paid to more effective features of some key time frames. Meanwhile, the data of each time point pays attention to other data in windows of different time ranges through the plurality of self-attention units with different time attention degrees, and an association relationship of the data in global and local time ranges can be obtained simultaneously by fusing the results of the plurality of self-attention units, so as to compensate the fact that the compression process only pays attention to “most important information”, and compared with the self-attention mechanism in the prior art in which “secondary information” is directly ignored during weighted average calculation, the integrity of the feature extraction of the electroencephalogram signal can be improved.

The step S73 specifically includes:

S731: acquiring the K matrix of each head of the multi-head self-attention mechanism, and calculating a mean and a variance of the feature values of the feature vectors under the same time frame in the K matrixes of all the heads.

Each head of the multi-head self-attention mechanism excavates characterization information of different time frames under different subspaces, each element can be associated with other elements in the sequence, and in the present invention, in order to compress the attention matrix, a key time is required to be found; that is, only a K value with large key information in each self-attention head is considered.

S732: sorting the feature values of the feature vectors under the same time frames in the K matrixes of all the heads in a descending order according to the mean, and selecting a first feature value with the variance meeting a variance threshold from top to bottom under each time frame to obtain the key characterization vector.

Specifically, for each feature vector under the same time frame, one K value is calculated under the self-attention mechanism, a mean and a variance of the K values calculated for the feature vector by all the heads are calculated, only the K value with the larger mean and the smaller variance is selected as a key characterization K value in each head, and the key characterization K values of a plurality of heads under each time frame are combined to obtain the key characterization vector: K=(K_{i,1}, K_{i,2}, . . . , K_{i,T})

wherein K represents the key characterization vector, and K_{i,T} represents the K value with the larger mean and the variance satisfying the variance threshold in the K matrix of an ith head of the spatial-temporal features under the time frame T.

In the present invention, considering the problem that the feature change between the adjacent time frames of the electroencephalogram signal is relatively slow, no clear boundary exists between the adjacent frames, and the similarity between each pair of time frames is difficult during calculation using attention, the key information is extracted by selecting the feature value with larger key information in each self-attention head from the original K matrix, so that the self-attention mechanism pays more attention to key time frame information.

The step S74 of compressing the Q matrix to obtain a compressed Q matrix includes:

S741: calculating the first attention weight matrix based on the key characterization vector and the Q matrix according to A₁=K̅Q; and

S742: sorting the first attention weight matrix in a descending order according to the weights, selecting time frames corresponding to first p weights as key time frames, and extracting Q values under the key time frames from the Q matrix to form the compressed Q matrix, p being a trainable parameter.

The key characterization vector is composed of K values with higher weights in the plurality of self-attention heads, so that a time frame with a smaller weight in the first attention weight matrix does not need more attention, and the original Q matrix is compressed through the weights. A number of the selected time frames may be adjusted for training according to the result of the self-attention module.

The original Q matrix is compressed through the first attention weight matrix, only the time frame with the large weight is selected as the key time frame, other time frames with low weights are not concerned, and 0 is assigned to the self-attention weights of the time frames, thereby reducing dot product operations, and increasing a model forming speed.

Due to complex characteristics of the electroencephalogram signal and addition of the multi-head self-attention mechanism with multiple time attention degrees, the feature extraction process is more complex, and a network hierarchy of the recognition model is large, but considering the real-time performance of electroencephalogram recognition, the electroencephalogram signal recognition model is optimized in a self-distillation mode in the present invention.

By self-distillation, a network (teacher model) with more parameters and a more complex structure is abstracted into a target network (student model) with a smaller scale and a smaller time delay, which can reduce the complexity of the network structure and achieve the characteristics of light training and a high feature migration efficiency, so as to ensure that the complexity and real-time requirements of the electroencephalogram signal are met.

The feature distillation in the step S3 includes:

S1301: taking the layers of the feature extraction layer and middle layers of the self-attention convolutional neural network as candidate distillation layers; the middle layers being the self-attention units.

S1302: adding a proper classification structure for each candidate distillation layer, the classification structure being configured to output a weak classification result for each candidate distillation layer.

It should be noted that the classification structures added for the candidate distillation layers can be deleted after network training is completed, and the finally obtained electroencephalogram signal recognition model does not additionally increase a response time.

S1303: obtaining mean precision of the classification structure of each candidate distillation layer, and calculating a distillation association value between any candidate distillation layers based on the mean precision; the distillation association value being a quotient of a mean precision product of two candidate distillation layers and a square of a number of spacing layers between the two candidate distillation layers.

The teacher is autonomously selected for the original network middle layer through the distillation association value, and compared with the prior art in which a last layer is manually selected as a teacher layer, a knowledge transfer effect is effectively improved, it is ensured that a deep layer contains knowledge which is not available in a shallow layer as far as possible, it is ensured that the deep layer and the shallow layer are not too close or too far away, and it can be ensured that knowledge of the deep layer is suitable for learning by the shallow layer as far as possible.

S1304: distributing single other candidate distillation layers to each candidate distillation layer to form a plurality of teacher student groups based on the distillation association value and the number of the preset spacing layers of teacher and student layers.

In all candidate distillation layers with the numbers of the spacing layers not larger than a preset spacing layer number, another candidate distillation layer which has the distillation association value larger than an association threshold and is closest to the current candidate distillation layer is distributed to the current candidate distillation layer, a shallow candidate distillation layer is used as the student layer, and the deep candidate distillation layer is used as the teacher layer.

S1305: calculating the feature similarity of two feature vectors of the same electroencephalogram signal in each teacher student group; the feature similarity being an Euclidean distance and used for measuring a difference degree of the candidate distillation layers with different depths.

The deeper the network layer is in the neural network, the closer the feature is to a real feature, the feature gradually gets close to the feature of a deepest layer with deepening of the layers, and the feature extraction of an (n+1)th layer is close to an nth layer by calculating the similarity of the features extracted by the student layer and the teacher layer for the same signal.

S1306: calculating the feature similarity of all the electroencephalogram signals to obtain a similarity matrix of each teacher student group, the feature similarity loss function being configured to solve minimization of the similarity matrix.

The deep layer knowledge is extracted by using deeper branches, the global feature information in the deep layer features is introduced into the shallow layer features to balance the feature difference between the deep layers and the shallow layers, the deep layer information is utilized to back feed and optimize the shallow layers, and the similarity of the shallow layers is refined to learn more accurate information originally in the deep layers in the shallow layers, so that shallow convolution can be better matched with deep layer results during prediction of spatial classification results.

The logic distillation in the step S3 includes:

S1401: taking the classification layer of the self-attention convolutional neural network as the teacher layer, and adding a shallow fully-connected classifier after the second layer of the feature extraction layer of the self-attention convolutional neural network as the student layer.

It should be understood that similar to the classification structure described above, the shallow fully-connected classifier added after the second layer of the feature extraction layer can be deleted after the network training is completed, and the complexity of the formed model is not increased.

S1402: calculating output of the student layer and the teacher layer through KL divergence to obtain the classification loss function.

During the logic distillation, a classifier at the deepest layer is used as a teacher classifier to guide learning of a classifier at the second layer of feature extraction as a student classifier. A difference between the classification results of two different depth layers can be obtained through classification loss, so that a shallow network can be better guided to learn spatial features.

In the present embodiment, the electroencephalogram signal recognition model is optimized by gradient descent, and the Adam optimizer is used, the learning rate is 0.0002, the learning rate of central loss is set to 0.00005, and the number of training rounds is set to 1000 rounds to meet the loss convergence requirements. The environment is a GTX3090 graphics card, and the training time is about 2 minutes to get a predictable model for use in the rehabilitation phase. The overall model parameters obtained by training are small, which can be recognized in real time, and the exoskeleton equipment can be quickly controlled, so as to realize the interaction between patients with movement disorders and external devices without delay, and the effect of assisted rehabilitation is remarkable.

The present invention is not limited to the above-described embodiments, and various modifications made by those skilled in the art without creative efforts from the above-described conception fall within the protection scope of the present invention.

What is claimed is:

1. A dyskinesia rehabilitation training method based on electroencephalogram signal recognition, employing a convolutional neural network to identify electroencephalogram signals, analyzing the patient's motor intention, transforming the motor intention into a control instruction for the exoskeleton device, and driving the patient's limb movement by controlling the movement of the exoskeleton device, wherein it comprises the following steps:
performing off-line training on a patient, collecting multi-modal electroencephalogram signal when the patient imagines different movement types to obtain the training phase data;
training the training stage data based on the self-attention convolutional neural network architecture to obtain an electroencephalogram signal recognition model;
collecting an electroencephalogram signal of the patient during on-line training as rehabilitation phase data, and inputting the rehabilitation phase data into the electroencephalogram signal recognition model to obtain a classification recognition result; and the motor control command was obtained based on the recognition results;
driving a corresponding limb to move based on the control command to complete dyskinesia rehabilitation training for the patient.

2. The dyskinesia rehabilitation training method based on electroencephalogram signal recognition according to claim 1, wherein training the training stage data based on the self-attention convolutional neural network architecture to obtain an electroencephalogram signal recognition model comprises:
S1, preprocessing the training stage data, which sequentially comprises: establishing a frequency domain filter based on band-pass filtering, performing standardization, and improving a common space mode algorithm to establish a space domain filter;
S2, establishing a self-attention convolutional neural network to extract a spatial-temporal feature of the electroencephalogram signal, determining a first loss function based on a predictive classification and a real classification of the self-attention convolutional neural network, and determining a second loss function based on a distance between the spatial-temporal feature and a corresponding spatial-temporal feature center;
S3, performing model optimization on the self-attention convolutional neural network in a self-distillation mode to obtain a third loss function;
S4, constructing a model total loss function based on a linear combination of the first loss function, the second loss function and the third loss function, and performing iterative training on the self-attention convolutional neural network to obtain an electroencephalogram signal recognition model.

3. The dyskinesia rehabilitation training method based on electroencephalogram signal recognition according to claim 2, wherein in the band-pass filtering of the step S1, data is filtered by a Chebyshev II filter to filter out irrelevant high-frequency and low-frequency noise; in the standardization, normalization is performed using Z-score to reduce volatility and non-stationarity of the data.

4. The dyskinesia rehabilitation training method based on electroencephalogram signal recognition according to claim 2, wherein the improving a common space mode algorithm to establish a space domain filter in the step S1 comprises:
S2131: grouping the multi-modal electroencephalogram signals according to movement types to form n classes of electroencephalogram signals, n being a total number of the movement types of the electroencephalogram signals;
S132: calculating a normalized covariance matrix R̅₁̅ of each class of electroencephalogram signals, i representing different movement types; obtaining a mixed spatial covariance matrix R of the multi-modal electroencephalogram signals based on the normalized covariance matrix R̅₁̅;
S133: performing principal component decomposition on the mixed spatial covariance matrix R of the multi-modal electroencephalogram signals;
S134: solving a common feature vector matrix Si based on the normalized covariance matrix R̅₁̅ and the principal component decomposition of each class of electroencephalogram signals, and performing principal component decomposition on the common feature vector matrix Si in the mode of the step S133 to obtain a feature value diagonal matrix Vi and a feature vector matrix Ui corresponding to the feature value diagonal matrix Vi of each class of electroencephalogram signals;
S135: performing approximate joint diagonalization on all the common feature vector matrixes Si to obtain relevant diagonal matrixes corresponding to the classes of electroencephalogram signals, and calculating an importance degree of each feature value λⱼ in each relevant diagonal matrix; the importance degree being the greater of the feature value λ and an inverse proportional function of the feature value λⱼ;
S136: sorting the feature values λⱼ in each relevant diagonal matrix in a descending order according to the importance degree, and recording a number of the same feature values λ; corresponding to the maximum importance degrees in the relevant diagonal matrixes; and
S137: if the feature values λⱼ corresponding to the maximum importance degrees in the relevant diagonal matrixes are the same, performing space domain filtering by adopting feature vectors corresponding to the feature values λⱼ with first n importance degrees in the relevant diagonal matrixes;
If the number of the same feature values λⱼ corresponding to the maximum importance degrees in the relevant diagonal matrixes is m, and m<n, the space domain filter is established by adopting the feature vectors corresponding to the feature values λⱼ with first m+1 importance degrees in the relevant diagonal matrixes.

5. The dyskinesia rehabilitation training method based on electroencephalogram signal recognition according to claim 2, wherein the self-attention convolutional neural network of the step S3 comprises:
feature extraction layer: for performing time domain and space domain convolution along a temporal dimension and a lead channel dimension to extract the spatial-temporal feature, and extracting global relevant information on a temporal position of the electroencephalogram signal from the spatial-temporal feature through a self-attention module;
central loss layer: for defining a central loss function as the second loss function based on a distance between the spatial-temporal feature and a corresponding spatial-temporal feature center, and minimizing an Euclidean distance between a center of a class feature and a sample feature; and
classification layer: for predictively classifying the spatial-temporal feature of the electroencephalogram signal extracted by the feature extraction layer using a fully-connected layer classifier, and calculating a cross entropy loss function between a predictive classification result and a real electroencephalogram classification label as the first loss function.

6. The dyskinesia rehabilitation training method based on electroencephalogram signal recognition according to claim 5, wherein the feature extraction layer divides a two-dimensional convolution operator into two one-dimensional convolutions for extracting a time domain feature and a space domain feature respectively, and specifically comprises a four-layer structure:
a first layer for performing a convolution operation using k convolution kernels with a size of (1, 25) and a step length of (1, 1) to extract a time domain feature of the electroencephalogram signal;
a second layer for using a kernel with a size of (N, 1) and a step length of (1, 1) to learn interaction between different lead channels and extract a space domain feature;
a third layer which is a temporal-dimension pooling layer, and has a kernel with a size of (1, 75) and a step length of (1, 15); and
a fourth layer for obtaining correlation of global time positions using the self-attention module.

7. The dyskinesia rehabilitation training method based on electroencephalogram signal recognition according to claim 6, wherein the self-attention module is a global self-attention module group, and the method comprises:
S71: determining time attention degrees of a plurality of self-attention units based on a time sequence length of the spatial-temporal features and a number of the self-attention units, and establishing the plurality of self-attention units with different time attention degrees which are connected in parallel to form the global self-attention module group;
S72: performing linear mapping on the spatial-temporal features based on the self-attention units with different time attention degrees to obtain attention matrixes under the corresponding time attention degrees: Q matrix, K matrix and V matrix; the attention matrixes having the same dimensions with matrixes of the spatial-temporal features;
S73: calculating an accumulated feature value of each feature vector under the same time frame in the K matrix in the corresponding self-attention unit to extract a key characterization vector from the K matrix;
S74: calculating a first attention weight matrix based on the key characterization vector and the Q matrix, and compressing the Q matrix according to weights in the first attention weight matrix to obtain a compressed Q matrix;
S75: completing a dimension of the compressed Q matrix to be the same as a dimension of the K matrix by using a zero vector to obtain a key Q matrix;
S76: calculating a second attention weight matrix based on the K matrix and the key Q matrix, and performing weighted summation on the V matrix by using the second attention weight matrix to obtain the output of the corresponding self-attention unit;
S77: performing mean filling on the output of the self-attention unit by using the V matrix of the spatial-temporal features;
S78: executing the above steps S72-S77 for the self-attention units with different time attention degrees of the global self-attention module group;
S79: splicing and normalizing the output of the self-attention units with different time attention degrees to obtain output of the global self-attention module group, i.e., the global relevant information at the temporal position of the electroencephalogram signal.

8. The dyskinesia rehabilitation training method based on electroencephalogram signal recognition according to claim 7, wherein a multi-head scaled dot product attention mechanism is adopted for a self-attention unit, the self-attention unit with each time attention degree comprises a multi-head self-attention mechanism and a fully-connected network, and a residual connection and normalization module is connected behind the multi-head self-attention mechanism and the fully-connected network; the plurality of self-attention units with different time attention degrees are connected in parallel through a splicing normalization layer.

9. The dyskinesia rehabilitation training method based on electroencephalogram signal recognition according to claim 8, wherein the step S73 of calculating an accumulated feature value of each feature vector under the same time frame in the K matrix in the corresponding self-attention unit to extract a key characterization vector from the K matrix comprises:
S731: acquiring the K matrix of each head of the multi-head self-attention mechanism, and calculating a mean and a variance of the feature values of the feature vectors under the same time frame in the K matrixes of all the heads; and
S732: sorting the feature values of the feature vectors under the same time frames in the K matrixes of all the heads in a descending order according to the mean, and selecting a first feature value with the variance meeting a variance threshold from top to bottom under each time frame to obtain the key characterization vector.

10. The dyskinesia rehabilitation training method based on electroencephalogram signal recognition according to claim 8, wherein the step S64 of calculating a first attention weight matrix based on the key characterization vector and the Q matrix, and compressing the Q matrix according to weights in the first attention weight matrix to obtain a compressed Q matrix comprises:
S741: calculating the first attention weight matrix based on the key characterization vector and the Q matrix; and
S742: sorting the first attention weight matrix in a descending order according to the weights, selecting time frames corresponding to first p weights as key time frames, and extracting Q values under the key time frames from the Q matrix to form the compressed Q matrix, p being a trainable parameter.

11. The dyskinesia rehabilitation training method based on electroencephalogram signal recognition according to claim 8, wherein the step S77 of performing mean filling on the output of the self-attention unit by using the V matrix of the spatial-temporal features comprises:
S771: calculating a mean of the V matrix of the spatial-temporal features in a range of the corresponding time attention degrees; and
S772: replacing data 0 in the output of the self-attention unit with the mean.

12. The dyskinesia rehabilitation training method based on electroencephalogram signal recognition according to claim 2, wherein the step S3 of performing model optimization on the convolutional neural network in a self-distillation mode to obtain a third loss function comprises:
taking a deep network layer of the self-attention convolutional neural network as a teacher model and a shallow network layer as a student model, and carrying out feature distillation and logic distillation on the neural network;
the third loss function comprising a feature similarity loss function in the feature distillation process and a classification loss function in the logic distillation process.

13. The dyskinesia rehabilitation training method based on electroencephalogram signal recognition according to claim 12, wherein the feature distillation comprises:
S1301: taking the layers of the feature extraction layer and middle layers of the self-attention convolutional neural network as candidate distillation layers; the middle layers being the self-attention units;
S1302: adding a proper classification structure for each candidate distillation layer, the classification structure being configured to output a weak classification result for each candidate distillation layer;
S1303: obtaining mean precision of the classification structure of each candidate distillation layer, and calculating a distillation association value between any candidate distillation layers based on the mean precision; the distillation association value being a quotient of a mean precision product of two candidate distillation layers and a square of a number of spacing layers between the two candidate distillation layers;
S1304: distributing single other candidate distillation layers to each candidate distillation layer to form a plurality of teacher student groups based on the distillation association value and the number of the preset spacing layers of teacher and student layers;
S1305: calculating the feature similarity of two feature vectors of the same electroencephalogram signal in each teacher student group; the feature similarity being an Euclidean distance and used for measuring a difference degree of the candidate distillation layers with different depths; and
S1306: calculating the feature similarity of all the electroencephalogram signals to obtain a similarity matrix of each teacher student group, the feature similarity loss function being configured to solve minimization of the similarity matrix.

14. The dyskinesia rehabilitation training method based on electroencephalogram signal recognition according to claim 12, wherein the logic distillation comprises:
S1401: taking the classification layer of the self-attention convolutional neural network as the teacher layer, and adding a shallow fully-connected classifier after the second layer of the feature extraction layer of the self-attention convolutional neural network as the student layer; and
S1402: calculating output of the student layer and the teacher layer through KL divergence to obtain the classification loss function.

15. The dyskinesia rehabilitation training method based on electroencephalogram signal recognition according to claim 4, wherein the defining, by the central loss layer, a central loss function as the second loss function based on a distance between the spatial-temporal feature and a corresponding spatial-temporal feature center comprises:
setting an initial central point of each electroencephalogram signal class as a zero vector or a random vector, outputting the spatial-temporal feature of the fourth layer of the feature extraction layer of the convolutional neural network as a sample feature vector, and calculating an Euclidean distance between each sample feature vector and a central point of the corresponding class as the second loss function.

16. A dyskinesia rehabilitation training system based on electroencephalogram signal recognition, comprising:
The electroencephalogram-evoked displays to present images of motor imagery stimuli to guide patient training;
The electroencephalogram acquisition device, which is used to collect electroencephalogram signals for patients to carry out motor imagination processes;
The electroencephalogram signal amplifier for amplifying the electroencephalogram signal to obtain a multimodal electroencephalogram signal and transmitting it; One end of the electroencephalogram signal amplifier is connected to the electroencephalogram acquisition device to receive the electroencephalogram signal collected by the electroencephalogram acquisition device; The other end is connected to the processor through the USB interface to transmit multi-modal electroencephalogram signals;
The processor for analyzing and processing multi-modal electroencephalogram signal to train and obtain electroencephalogram signal recognition model and generate control instructions;
The exoskeleton device transmits control instructions with the processor through the TCP/IP protocol, and is used to control the patient's exoskeleton to achieve corresponding movement actions after identifying the control instructions.
